(19) United States
(12) Patent Application Publication
(10) Pub. No.: US 2024/0342658 A1
(43) Pub. Date: Oct. 17, 2024

(54) Energy Recovery Ventilator

(71) Applicant: USA FORTESCUE IP, INC., Wilmington, DE (US)

(72) Inventors: Bamdad Bahar, Georgetown, DE (US); Abhishek Bandlore, Milford, DE (US); Jacob Zerby, Dover, DE (US)

(21) Appl. No.: 18/629,689

(22) Filed: Apr. 8, 2024

Related U.S. Application Data
(63) Continuation-in-part of application No. 18/097,485, filed on Jan. 16, 2023.
Application No. 18/097,485 is a continuation of application No. 17/095,993, filed on Nov. 12, 2020, now Pat. No. 11,554,347.
Application No. 17/095,993 is a continuation-in-part of application No. 16/872,098, filed on May 11, 2020, now Pat. No. 11,318,421.
(63) Continuation-in-part of application No. 17/552,965, filed on Dec. 16, 2021.
(63) Continuation-in-part of application No. 17/979,727, filed on Nov. 2, 2022.
Application No. 17/979,727 is a continuation-in-part of application No. 16/273,097, filed on Feb. 11, 2019, now abandoned.
Application No. 16/273,097 is a continuation-in-part of application No. 15/800,398, filed on Nov. 1, 2017, now Pat. No. 10,890,344.
Application No. 15/800,398 is a continuation-in-part of application No. PCT/US16/63699, filed on Nov. 23, 2016.
(60) Provisional application No. 62/846,034, filed on May 10, 2019.
(60) Provisional application No. 62/846,030, filed on May 10, 2019.
(60) Provisional application No. 63/126,511, filed on Dec. 16, 2020.
(60) Provisional application No. 62/258,945, filed on Nov. 23, 2015.
(60) Provisional application No. 62/300,074, filed on Feb. 26, 2016.
(60) Provisional application No. 62/353,545, filed on Jun. 22, 2016.
(60) Provisional application No. 62/373,329, filed on Aug. 10, 2016.
(60) Provisional application No. 62/385,175, filed on Sep. 8, 2016.
(60) Provisional application No. 62/416,072, filed on Nov. 1, 2016.
(60) Provisional application No. 62/629,044, filed on Feb. 11, 2018.
(60) Provisional application No. 63/274,898, filed on Nov. 2, 2021.
(60) Provisional application No. 63/458,082, filed on Apr. 7, 2023.

(51) Int. Cl. B01D 63/06; B01D 61/36; B01D 63/10; B01D 69/02; B01D 69/12; B01D 71/26; B01D 71/52; B01D 71/56; B01D 71/60; B01D 71/80

(52) U.S. Cl. CPC B01D 63/06; B01D 61/362; B01D 61/366; B01D 63/10; B01D 69/02; B01D 69/1213; B01D 69/1216; B01D 71/261; B01D 71/262; B01D 71/52; B01D 71/56; B01D 71/60; B01D 71/80; B01D 2325/04; B01D 2325/48

(57) ABSTRACT

Composite polyether block amide (PEBA) copolymer tubes incorporate an ultra-thin PEBA extruded layer that enables rapid moisture transfer and exchange through the tube. An extruded composite PEBA film may include a porous scaffold support and may be formed or incorporated into the composite PEBA tube. An extruded PEBA may be melted into pores of a porous scaffold support. Extruded PEBA may be wrapped on a mandrel or over a porous scaffold support to form a composite PEBA tube. A film layer may be applied over a wrapped composite PEBA film to secure the layers together. A support tube may be configured inside or outside of the PEBA tube.

### CROSS REFERENCE TO RELATED APPLICATIONS

This application is a continuation in part of U.S. patent application Ser. No. 18/097,485, filed on Jan. 16, 2023 and currently pending, which is a continuation of U.S. patent application Ser. No. 17/095,993, filed on Nov. 12, 2020 and issued as U.S. Pat. No. 11,554,347, which is a continuation in part of U.S. patent application Ser. No. 16/872,098, filed on May 11, 2020 and issued as U.S. Pat. No. 11,318,421 on May 3, 2022, which claims the benefit of priority to U.S. provisional patent application No. 62/846,034, filed on May 10, 2019, and U.S. provisional patent application No. 62/846,030, filed on May 10, 2019, and this application is a continuation in part of U.S. patent application Ser. No. 17/552,965, filed on Dec. 16, 2021 and currently pending, which claims the benefit of priority to U.S. provisional patent No. 63/126,511 filed on Dec. 16, 2020; and this application is a continuation in part of U.S. patent application Ser. No. 17/979,727, filed on Nov. 2, 2022 and currently pending, which is a continuation in part of to U.S. patent application Ser. No. 16/273,097, filed on Feb. 11, 2019 and abandoned, which is a continuation in part of U.S. patent application Ser. No. 15/800,398, filed on Nov. 1, 2017 and issued as U.S. Pat. No. 10,890,344, which is a continuation in part of international application No. PCT/US2016/063699, filed on Nov. 23, 2016, which claims the benefit of priority to U.S. provisional patent application No. 62/258,945, filed on Nov. 23, 2015, and U.S. provisional patent application No. 62/300,074, filed on Feb. 26, 2016, and U.S. provisional patent application No. 62/353,545, filed on Jun. 22, 2016, U.S. provisional patent application No. 62/373,329, filed on Aug. 10, 2016, U.S. provisional patent application No. 62/385,175, filed on Sep. 8, 2016, and application Ser. No. 15/800,398 claims the benefit of priority to U.S. provisional patent application No. 62/416,072 filed on Nov. 1, 2016, and application Ser. No. 16/273,097 claims the benefit of priority to U.S. provisional patent application No. 62/629,044 filed on Feb. 11, 2018, and application Ser. No. 17/979,727 claims the benefit of priority to U.S. provisional patent application No. 63/274,898, filed on Nov. 2, 2021, and this application claims the benefit of priority to U.S. provisional patent application No. 63/458,082 filed on Apr. 7, 2023; the entirety of all prior applications are hereby incorporated by reference herein.

### BACKGROUND OF THE INVENTION

### Field of the Invention

The present invention relates to ion transport membrane systems and their integration into pervaporation or heat/mass exchange systems such as drying or humidifying gases, purification, medical, analytical, HVAC and oil & gas applications and in particular to sheets or tubes comprising (PEBA) membranes and modules incorporating said extruded tube for pervaporation or heat/mass exchange systems such as drying or humidifying gases, purification, medical, analytical, HVAC and oil & gas applications. The process for manufacturing above-mentioned tubular systems is provided and devices incorporating these tubes are also provided.

### Background

Polyether block amides (PEBAs) are a family of high performance block copolymers consisting of soft polyether (PE) blocks and rigid polyamide (PA) blocks marketed under the PEBAX® and VESTAMID® brands by Arkema Inc and EVONIK Resource Efficiency Gmbh, respectively. Arkema first commercialized PEBAX® thermoplastic elastomers in 1981 as part of an initiative to develop “soft” nylon materials. PEBAX® has the general formula of: HO—(CO-PA-CO—O-PE-O)ₙ—H.

Polyamide block is in a rigid semi-crystalline phase, which contributes to high end mechanical properties and can be optionally bio-based from 28% to 97%, according to ASTM D6866. While polyether block has a very low glass transition temperature of about-60° C., which provides outstanding properties at low temperature. In addition, polyether block can be tuned to hydrophobic or hydrophilic.

PEBA is a high-performance thermoplastic elastomer with these following characteristics: resistance against a wide range of chemicals, low density among thermoplastic elastomers, superior mechanical and dynamic properties including, flexibility, impact resistance, energy return, fatigue resistance, and these properties are maintained at low temperature, such as lower than −40° C.

PEBA is used in medical products such as catheters for its flexibility, its good mechanical properties at low and high temperatures, and its softness.

It is also widely used in the manufacture of electric and electronic goods such as cables and wire coatings, electronic device casings, components, etc. PEBA can be used to make textiles as well as breathable film, fresh feeling fibers or non-woven fabrics. These compounds will find various applications in sports, optical, and electronics, where toughness and lightness are crucial. Some hydrophilic grades of PEBA are also used for their anti-static and anti-dust properties. Since no chemical additives are required to achieve these properties, products can be recycled at end of life.

PEBA has a unique copolymer structure that can be hydrophilic. Hydrophilic PEBA films offer a combination of mechanical strength, and ease of processing. Unlike microporous products, the monolithic structure of these PEBA films are a barrier to liquid water and bacteria and exhibit a high moisture vapor transmission rate (MVTR). Each of these advantages make PEBA films breathable. This material is ideal for many applications such as construction house-wrap films, breathable textiles for sports, packaging, and selective films or membranes.

To achieve even higher MVTR, PEBA films need to be very thin. However, thinner films demonstrate poor mechanical strength and dimensional stability. Traditionally, to date, thicker PEBA films are produced. Thicker PEBA films have high transmission resistance, and lower pervaporation performance. In fact, some PEBA films are made by melt extrusion into a thin monolithic film above 25 μm, or microns, which limits their application.

Certain PEBAX® and VESTAMID® grades are extruded as tubes for medical applications such as in catheters, intravenous (IV) lines and balloons. But these grades are not hydrophilic and cannot be used in application involving movement of water vapor through the wall of the tube. The tube walls are also not thin enough, further reducing the moisture vapor transmission of the material.

### SUMMARY OF THE INVENTION

The invention is related to an advanced energy recovery ventilator that utilizes polyether block amide (PEBA) for permeation of water. The PEBA may be ultra thin and configured in a sheet or tube of an ERV module. The PEBA may be a composite PEBA layer, and may be configured in a tube wherein the PEBA material is combined with a support material, such as a porous support material. Also, the PEBA may be extruded into a very or ultra thin wall tube and may be extruded over a support material or onto a support material.

This system is anticipated to improve performance by at least 23% over conventional systems, enabling ERV systems to increase their energy benefit to 7.4. Quads nationally over a 20-year period i.e. energy savings would increase by 0.8 Quads over current, commercially available fixed-plate ERV exchangers.

It should be noted that ERVs, within standard ventilation systems, provide an opportunity to downsize heating and air-conditioning equipment due to load reductions by enabled by the ERV. An improved ERV system would therefore also allow for significant additional operational cost savings. It should also be noted that the US market has been poorly penetrated. An improved ERV core would be transformational and disruptive, enabling significant expansion of the current market for ERVs by improving economic payback for buyers. This would yield further energy savings not captured in our calculations.

Fixed-plate ERVs are simple devices: exhaust air moves through a channel formed between two parallel membrane plates and maintained by a flow-field separator. Immediately opposite the ERV membrane from the exhaust air, supply air moves through a similar flow field separator.

Academic studies suggest that the airside boundary layer can account for as much as 95% of the overall heat transfer resistance (5,6). However, analysis of commercially available membrane ERV exchangers attribute most of the moisture transfer resistance to the membrane, with airside (boundary layer) moisture transfer resistance estimated at only 10-35% of the total moisture transfer resistance (7). To maximize the energy-saving potential of fixed-plate ERVs, both the airflow dynamics through the membrane exchanger as well as water permeability characteristics of the membranes must be improved.

Over the past 30 years, commercial ERV cores have been developed for low construction cost, and not for optimized performance. With much of the U.S. supply coming from overseas, margins are squeezed, and no-one in the U.S. is in the position to expend resources to do research to improve performance. Significant improvements are feasible, yet no single entity can address these developments without the formation of a consortium and grant support.

An exemplary energy recovery ventilator may be used in a wide variety of applications including, a desiccator, such as for an ionic liquid desiccant, as a component of a sensor, as a component of used in electrolysis, as a component of a battery, as a component of an ultracapacitor, as a component of an electrochemical compressor, or a pervaporation device.

Membranes used in pervaporation devices such as evaporative coolers and liquid desiccant systems may utilize a pervaporation membrane which may be a composite ion exchange membrane. The membranes may be exposed to harsh chemicals and particulate matter in air. Porous membranes offer hydrophobicity and high moisture vapor transmission rates but are prone to fouling and degradation. Addition of a thin-film coating of an ionomer such as perfluorosulfonic acid (PFSA) renders the membrane nonporous and drastically improves membrane durability. Durability and chemical resistance are especially important in liquid desiccant-based air-conditioning systems where highly corrosive salts are used. Furthermore, although the coating adds thickness to the membrane, an optimum thickness of ionomer/hydrophilic polymer was found to improve the permeance of the membrane by as much as 40%.

It is surprising that this coating improves performance as it is a continuous film coating layer, however it is so thin, less than 5 microns, that the rate of water transfer is high enough to not negatively affect the performance. This coating also prevents clogging of the supports.

A thin film may be an ultra-thin extruded PEBA tubes made from elastomeric polyether block amide (PEBA), preferably ultra-thin composite PEBA films, or membranes, and modules comprising these extruded tubes. An exemplary extruded PEBA tube may be made of Pebax® 1657 with a wall thickness of about 100 μm or less, 75 μm or less, about 50 μm or less, and preferably 25 μm or less, and more preferably about 10 μm or less, and even more preferably about 5 μm or less. The thinner the wall thickness the higher the rate of moisture vapor transport therethrough.

One drawback of manufacturing tubes using tape wrapping techniques is that mass production in continuous form for extended lengths is complex. An alternative approach to manufacturing these tubes would be to produce them by extrusion i.e. by melting the PEBA polymer pellets, pushing the hot PEBA liquid out through the extrusion head and drawing the cooled tube continuously. While extrusion itself is well established in the art, the tubes provided here-in, involve additives in addition to the PEBA itself that enable the use of these tubes in specific applications, and then incorporation of these tubes into devices is also novel.

Some grades of PEBA that may be suitable for extrusion include, but are not limited to, Pebax® MH 1657, Pebax® MV 1041, Pebax® MV 1074 and Pebax® MV 3000; these are all water permeable PEBA grades offered by Arkema with 1657 being the most water permeable grade.

According to one embodiment of the present invention, an additive is provided that reinforces the PEBA that is added to the extruded tube to improve structural integrity. The ultra-thin extruded tube with a wall thickness of less than 75 μm would be ‘flimsy’ or ‘weak’ due to its thinness. The walls tend to collapse, and the tube tends to kink along the length making the handling difficult. In addition, the tube expands longitudinally and laterally when it takes up water, which is undesirable. Adding a reinforcement to the tube in the form of a braided sleeve helps in improving the mechanical properties while providing a constraint for elongation. A braided sleeve may be added as the tube emerges from the extrusion head, or by extruding the tube directly on the braided sleeve. This can result in the braided sleeve being on the outside of the extruded PEBA tube or inside of the extruded PEBA tube or embedded within the wall of the extruded PEBA tube. Since water vapor permeation through the PEBA tube is a function of area available for permeation, the braided sleeve open area is ideally greater than 60% for satisfactory water vapor transmission rate and preferably greater than 70% or even 90%. The braided sleeve may be made out of metal, such as stainless steel, or a polymer, such as polyester or polyethylene terephthalate (PET). The metal may also be used to enhance heat transfer to the tubular structure to enhance pervaporation. The braided sleeve may be secured on the ends of the tubular structure using an adhesive or a heat shrinking material or a clamp.

According to another embodiment of the present invention, additives maybe added in the extruded tube to improve mechanical properties. The additives may be a crosslinking agent or a structural additive such as particulates or fibers such as fiberglass, or microspheres, or finely divided ceramic particles that are added into the molten PEBA before extrusion. Exemplary Cross-linking agents include, but are not limited to: 2-Mercaptoethanol, Toluene 2,4-diisocyanate, 3-Aminopropyl (diethoxy) methylsilane.

According to another embodiment of the present invention, the extruded tube may contain biocides such as Diiodomethyl p-tolyl sulfone, ZPT (Zinc 2-pyridinethiol-1-oxide), DCOIT (4,5-dichloro-2-n-octyl-3 (2H)-isothiazolone), OIT (2-n-octyl-4-isothiazolin-3-one) to inhibit mold formation and kill bacteria. These are added into the molten PEBA before extrusion. The extruded tube may also have additives that improve the hygroscopicity of the material, such as desiccants. Desiccants can be silica based or salt based such as calcium chloride. Desiccants may be added in a relatively low concentration of about 10% or less, or even 5% or less. A high concentration of the desiccant may compromise the strength of the extruded PEBA tube. Obviously, a combination of additives may be necessary. An extruded PEBA film may be extruded onto or otherwise incorporated with a porous scaffold support. AAn ultra-thin composite PEBA film may be made into a PEBA pervaporation tube, or composite PEBA tube, by wrapping a composite PEBA film around a support tube, such as a porous polymeric tube, and bonding or attaching the overlap areas of the wrapped PEBA film. A composite PEBA tube can be made by spirally wrapping or longitudinally wrapping a PEBA film or wrapping a porous scaffold support around an ultra-thin walled extruded PEBA tube. A mandrel may be used for wrapping the composite PEBA film thereon. These thin composite PEBA tubes, may be used as pervaporation tubes that can be incorporated into a pervaporation module. The wrapped composite PEBA pervaporation tube may have fused areas wherein at least a portion of the overlap area is fused together.

Composite PEBA tubes manufactured through a wrapping process may have low burst pressure as the layers may separate. Two PEBA layers overlapping often do not form an integral bond during annealing and processing. The expansion and contraction of the tubes during wetting and drying breaks the interface seal between two overlapping layers causing a system leak. Higher pressures with dry gases will also leak. Additional steps may be required to ensure the composite PEBA tubes maintain structural integrity during operation.

To improve structural integrity, a PEBA composite tube, once wrapped, may have a layer of polymer added to the external and/or internal surface. This continuous layer further imbibes into the exposed composite surface and acts as a sheath to avoid rupture between the overlapping layers. The layer of polymer may be PEBA polymer or comprise PEBA polymer.

The porous scaffold support may include a porous material and the PEBA may be coated thereon and may fill, at least partially the pores of the porous material or membrane. An exemplary porous scaffold support material is a porous polymer material of polyethylene or polypropylene, and may be a porous fluoropolymer material or membrane, such as an expanded fluoropolymer. An exemplary expanded fluoropolymer is expanded polytetrafluoroethylene (PTFE). An exemplary porous scaffold support material has a thickness that is less than about 25 μm, less than about 20 μm, less than about 10 μm and more preferably less than about 5 μm. A thin porous material is preferred as it will allow for higher rates of moisture transfer through the composite PEBA tube. A porous scaffold support, such as an expanded fluoropolymer or porous polyethylene or polypropylene, may have very small pores, wherein the average pores size is no more than about 10 μm, no more than about 5 μm, no more than about 1 μm, no more than about 0.5 μm and any range between and including the values provided. The average pore size can be determined use a coulter porometer, wherein the Minimum Pore Size is defined at the point where the wet curve meets the dry curve. The Mean Pore Size is defined as the point at which the amount of flow through the sample on the wet curve is exactly 50 percent of the amount of flow at the same pressure when the sample is dry. A small average pore size may be desirable to enable PEBA to imbibe into the pores of the porous scaffold material. The smaller the pore size the greater the capillary forces to pull the solution or melted PEBA therein.

The PEBA may be attached to the porous scaffold support by melt casting, wherein the PEBA is extruded and melted onto the porous scaffold support. The two layers may then be compresses to force the melted PEBA into the pores of the porous scaffold support. PEBA may also be solution cast onto or into the pores of a porous scaffold support. The PEBA may be dissolved in a solvent and the cast onto the porous scaffold support, wherein it may wick into the pores and substantially fill the pores to make a non-permeable composite film. In flat sheet assemblies, such as a vent or plate and frame pervaporation modules, it may be desirable to have minimal PEBA integration into the pores of the porous scaffold support and therefore melt casting may be preferred with little interpenetration of the PEBA into the pores. It is also possible to achieve a composite structure with minimal penetration by solution casting and tuning the solvent system to evaporate before the PEBA is able to penetrate the pore structure fully.

A composite PEBA film comprising the PEBA polymer and the porous scaffold support may be substantially non-porous, wherein the pores of the porous scaffold support are filled or blocked by the PEBA polymer such that the composite PEBA film has no bulk flow of gas therethrough, having a Gurley densometer reading of about 100 seconds or more, and preferably 200 second or more; using a Gurley Densometer 4340 automatic densometer, from Gurley Precision Instruments, Troy NY.

The composite PEBA film may be wrapped to form a tube and may include overlap areas that are fused together. These overlap areas will be at least twice as thick as the composite PEBA film and therefore it may be desirable to keep the overlap area to a minimum percentage of the outer surface area of the composite PEBA tube, such as no more than about 30%, no more than about 25%, no more than about 20%, no more than about 10%, or even no more than about 5% of the outside surface area of the tube.

A continuous layer may be added to the PEBA tube structure to secure the PEBA film in place and prevent leakage. A continuous layer may comprise PEBA or may be a polymer with sufficient moisture transfer properties as to not inhibit the performance of the tubes, such as permeation through the PEBA film. The continuous layer may be applied to the outer surface, inner surface, or both. Preferably, a composite PEBA tube, as described herein, is dip coated such that the internal layer and external layer are a continuous surface. The additional PEBA layer may contain additives to further enhance the mechanical properties of the tubular structure. The additives may be a crosslinking agent or a structural additive such as fiberglass. Exemplary Cross-linking agents include, but are not limited to: 2-Mercaptoethanol, Toluene 2,4-diisocyanate, 3-Aminopropyl (diethoxy) methylsilane.

According to one embodiment of the present invention, there is provided a tubular structure made from a composite film of a porous scaffold support and PEBA copolymer. The tubular structures have overlapping fused areas.

According to one embodiment of the present invention, there is provided a process for the preparation of the composite membrane tubing by tape-wrapping a porous scaffold support around a mandrel. The mandrel is then passed through a heating chamber or an infrared chamber to fuse the wrapped tape into a continuous tubular structure. The tubular structure is then passed through a coating process wherein the membrane tube is coated with the PEBA copolymer. The assembly is then passed through heating chamber to dry the PEBA pervaporation tube. Then the tube is dipped in a swelling agent, such as water or a solvent, and removed from the mandrel. It may be necessary to provide internal pressure to the tube assembly to remove the PEBA tube from the mandrel.

According to one embodiment of the present invention, there is provided a process for the preparation of tubular structure adapted to pervaporate the fluid by spirally or longitudinally, also referred to as cigarette, wrapping one or more membranes or PEBA films around a mandrel and using heat or infrared radiation on the assembly to fuse the wrapped membrane tapes into a continuous cylindrical tube. Then the tube is dipped in a swelling agent, such as water or a solvent, and removed from the mandrel. It may be necessary to provide internal pressure to the tube assembly to remove the PEBA tube from the mandrel. Note that an ultrasonic instrument, such as an ultrasonic welder, having an ultrasonic horn and anvil, such as a those available from Branson Ultrasonics Corp, Rochester NY, may be used to create very localized heat between the overlapped layers of the wrapped tube to fuse the layers together.

According to one embodiment of the present invention, there is provided a process for the preparation of composite PEBA tube that is adapted to pervaporate a fluid. The composite PEBA tube may be made by spirally or longitudinally, also referred to as cigarette, wrapping one or more composite PEBA films around a mandrel. A polymer layer is applied to the outer and/or inner surface of the tubular structure using some form of dip-coating, spraying or painting. Heat or infrared radiation is applied to the tubular structure to fuse the wrapped PEBA films into a continuous cylindrical tube. Then the composite PEBA tube is dipped in a swelling agent, such as water or a solvent, and removed from the mandrel. It may be necessary to provide internal pressure to the tube assembly to remove the PEBA tube from the mandrel. Note that an ultrasonic instrument, such as an ultrasonic welder, having an ultrasonic horn and anvil, such as a those available from Branson Ultrasonics Corp, Rochester NY, may be used to create very localized heat between the overlapped layers of the wrapped tube to fuse the layers together.

An alternative embodiment of the present invention involves extruding tubes to a very thin cross-sectional thickness and optionally reinforcing with a reinforcement after extrusion, such as by tape wrapping.

An exemplary PEBA composite film may include a biocide to prevent the formation of mold in a pervaporation module, as this is an ideal environment for mold to form. A biocide may be configured in the PEBA polymer, as a coating on the porous scaffold support, as a coating on the final PEBA layer, or a combination thereof. Any suitable biocide may be used and the concentration may be adjusted according to the use conditions.

According to one embodiment of the present invention, a tube reinforcement may be configured around the outside and/or inside of a composite PEBA tube to provide additional structural support and may comprise a structural mesh. A structural mesh may be configured around the PEBA tube(s) to provide additional structural rigidity. The structural mesh may comprise a plastic or metal material depending on the degree of reinforcement required. The metal may also be used to enhance heat transfer to the tubular structure to enhance pervaporation. The structural mesh may be secured on the ends of the tubular structure using an adhesive or a heat shrinking material, or a combination of the two.

According to one embodiment of the present invention, a method for putting fittings at the ends of the tubes is provided. The fittings may be coupled to the composite PEBA tube by inserting a rigid plastic tubing at the ends of the PEBA tubing, and inserting into the plastic tubing different kinds of fittings such as compression, barbed, push-to-connect, etc. The assembly may be secured on the ends of the tubular structure using an adhesive or a heat shrinking material, or a combination of the two. Alternatively, tubes, with or without fittings, are inserted into a setting compound, or potted, into a tube sheet or header.

The thinness of the tubes along with the inherent nature of the material ensures tubes which permeate water, water vapor or a polar species to transmit across the tube wall at higher rates and lower cost.

According to one embodiments of the present invention, there are provided devices such as modules that employ pervaporative tubing to dry incoming air streams for medical, analytical, electrochemical and oil & gas purposes. Several pervaporative tubes are forced into a cylindrical structure which constitutes the “shell”. The pervaporative tubes are capped off and then dipped into potting resin. Once, the potting resin and seals all tubes in place, the process is repeated on the other end of the tubes. Finally, the ends are capped off with front and rear headers.

Ultra-thin composite PEBA film can be used to make tubes. These tubes are very strong, and therefore can take high pressure feed. The composite PEBA film may include a PEBA film layer that is non-porous and a porous scaffold support layer.

Because of the strength and thinness, there is less resistance to permeation and therefore higher performance systems.

Because of the ultra-thin structure, less material, both PEBA and porous scaffold support, are used to produce these tubes, therefore the units have inherently lower cost, and therefore the technology can be applied to wider range of applications beyond the current thick walled extruded tubes that are state-of-art in the market.

The pervaporation modules and pervaporation tubes comprising a PEBA copolymer and preferably an ultra-thin composite PEBA film are ideally suited for desalination, ionic liquid desiccation, waste processing, heat exchange, mass exchange and numerous other applications.

The desired ultra-thin composite PEBA tubing will also have the following merits: high dimensional stability; high moisture vapor transmission rate; lightweight; excellent toughness and tear resistance; easy for processing in a roll-to-roll scale up; low cost; anti-dust; recyclable; excellent virus and bacteria barrier; excellent liquid & odor barrier and hygienic.

The desired ultra-thin reinforced composite PEBA film should have the following features: no curl, easy to handle; good dimensional stability; high MVTR; lightweight; excellent toughness and tear resistance; easy to process in high volume, such as a roll-to-roll system; low cost; recyclable; flexible; act as an excellent virus and bacteria barrier; and be an excellent liquid & odor barrier and be hygienic.

### EXAMPLE 1

In one embodiment, an ultra-thin reinforced composite PEBA film is prepared by dissolving the PEBA, MV1074 from Arkema Inc., in ethanol/toluene (50 wt %: 50 wt % mix) at a 15% weight ratio. The mixture was stirred at 60° C. until homogenous and translucent. The PEBA polymer solution was then applied to a microporous polytetrafluoroethylene material which is tensioned around a chemically-resistant plastic frame. The polymer solution was then poured on to the microporous scaffold. The composite PEBA film was dried at room temperature. The final thickness of the composite PEBA film was 5 μm.

### EXAMPLE 2

In another embodiment, an ultra-thin reinforced composite PEBA film is prepared by dissolving the PEBA MH1657 polymer from Arkema Inc., in ethanol and water at a 20% weight ratio. The mixture was stirred until homogenous and translucent. The PEBAX® MH1657 polymer was then applied to a microporous polyethylene material using a doctor blade. The composite PEBA film was dried at room temperature for 8 hours. The composite PEBA film was then annealed in the oven for 5 minutes at 80° C. The final thickness of the composite PEBA film was 5 μm.

### EXAMPLE 3

In another embodiment, an ultra-thin reinforced composite PEBA/PFSA film is prepared by dissolving the 1.6 g PEBA polymer from Arkema Inc. and 0.4 g PerfluoroSulfonicAcid, (PFSA) in ethanol and water at a 20% weight ratio i.e. 2 grams of total polymer to 8 grams of solvent. The mixture was stirred until homogenous and translucent. The PEBA/PFSA blend polymer was then applied to a microporous polyethylene material with a doctor blade. The film was dried at room temperature for 24 hours. The final thickness of the film was 15 microns.

It will be apparent to those embodiments mentioned above can be scaled up to a roll-to-roll, continuous process.

### EXAMPLE 4

In another embodiment, an ultra-thin reinforced composite PEBA film is prepared by melt lamination of PEBA, MH1657 at about 20 micron onto expanded polytetrafluoroethylene (ePTFE) support scaffold materials. MH1657 was hot pressed with ePTFE at 200° C. for 90 seconds. The film was 7 micron and transparent.

According to one embodiment of the present invention, a method for adding fittings at the ends of the tubes is provided. The fittings may be coupled to the composite PEBA tube by inserting a rigid plastic tubing at the ends of the PEBA tubing, and inserting into the plastic tubing different kinds of fittings such as compression, barbed, push-to-connect, etc. The assembly may be secured on the ends of the tubular structure using an adhesive or a heat shrinking material, or a clamp. Alternatively, tubes, with or without fittings, are inserted into a setting compound, or potted, into a tube sheet or header.

The thinness of the tubes along with the inherent nature of the material ensures tubes which permeate water, water vapor or a polar species to transmit across the tube wall at higher rates and lower cost.

According to one embodiments of the present invention, there are provided device such as modules that employ pervaporative tubing to dry incoming air streams for medical, analytical, electrochemical, and oil & gas purposes. Several pervaporative tubes are forced into a cylindrical structure which constitutes the “shell”. The pervaporative tubes are capped off and then dipped into potting resin. Once, the potting resin seals all tubes in place, the process is repeated on the other end of the tubes. Finally, the ends are capped off with front and rear headers.

Because of the strength and thinness, there is less resistance to permeation and therefore higher performance systems.

The pervaporation modules and pervaporation tubes comprising ultra-thin extruded PEBA tubes are ideally suited for desalination, ionic liquid desiccation, waste processing, heat exchange, mass exchange and numerous other applications. A flow of fluid may be passed through the ultra-thin extruded PEBA tubes and a flow of gas, such as air may be passed over the ultra-thin extruded PEBA tubes to draw moisture from the ultra-thin extruded PEBA tubes to increase humidity of the gas stream. The fluid flowing through the ultra-thin extruded PEBA tubes may be water, or a ionic liquid or aqueous salt solution for desiccation. A fluid may be passed through the ultra-thin extruded PEBA tubes and another fluid, which may be a liquid may flow over the ultra-thin extruded PEBA tubes. The ultra-thin extruded PEBA tubes can be incorporated into a shell-and-tube module and vacuum may be drawn on the shell side so cooling or dehumidification can be achieved.

The desired ultra-thin extruded PEBA tubing will also have the following merits: high dimensional stability; high moisture vapor transmission rate; lightweight; excellent toughness and tear resistance; low cost; anti-dust; recyclable; excellent virus and bacteria barrier; excellent liquid & odor barrier and hygienic.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description explain the principles of the invention.

FIG. 1 shows cross-sectional view of an exemplary porous scaffold support having a porous structure and pores therein, wherein the PEBA substantially fills the pores of the scaffold support.

FIG. 2 shows a cross-sectional view of an exemplary ultra-thin composite PEBA film having a layer of PEBA on either side of the porous scaffold support.

FIG. 3 shows cross-sectional view of an exemplary ultra-thin composite PEBA film formed by imbibing PEBA copolymer into a porous scaffold support using solution casting process, wherein the PEBA substantially fills the pores of the scaffold support.

FIG. 4 shows a cross-sectional view of a composite PEBA film having a butter-coat layer of PEBA on the surface of a porous scaffold support.

FIG. 5 shows a cross-sectional view of an overlap region of a composite PEBA tube having two layers of composite PEBA film.

FIG. 6 shows a perspective view of an exemplary PEBA tube that is a spirally wrapped PEBA tube comprising a spirally wrapped composite PEBA film having overlap areas that are attached form a spiral wrapped PEBA tube.

FIG. 7 shows a perspective view of an exemplary PEBA tube that is a longitudinally wrapped PEBA tube comprising a spirally wrapped composite PEBA film having overlap areas that are attached form said cigarette wrapped PEBA tube.

FIG. 8 shows pervaporation module compromising a plurality of composite PEBA pervaporation tubes.

FIG. 9 shows a cross sectional view of an exemplary composite PEBA tube having a PEBA polymer layer on the outside surface of the porous scaffold support and a film layer configured over the PEBA layer.

FIG. 10 shows a cross sectional view of an exemplary composite PEBA tube having a PEBA polymer layer on the inside surface of the porous scaffold support and a film layer configured over the PEBA layer.

FIG. 11 shows a cross sectional view of an exemplary composite PEBA tube having a PEBA polymer layer on both the inside and the outside surface of the porous scaffold support and a film layer over both PEBA layers.

FIG. 12 shows cross-sectional view of an ultra-thin extruded PEBA tube.

FIG. 13 shows cross-sectional view of an ultra-thin extruded PEBA tube.

FIG. 14 shows cross-sectional view of a pervaporation module comprising a plurality of PEBA pervaporation tubes.

FIG. 15 shows a perspective view of a tube support that is permeable having apertures therethrough or tube pores.

FIG. 16 shows a perspective view of an exemplary energy recovery ventilator.

FIG. 17 shows a perspective view of an exchange module of an exemplary energy recovery ventilator having a pleated transfer medium forming flow channels.

FIG. 18 shows diagrams of exemplary air twisters for an ERV.

FIG. 19 shows a cross-sectional diagram of an exemplary composite ion-exchange membrane.

FIG. 20 shows a graph of water permeance vs. projected materials cost for various polymer membranes.

FIG. 21 shows a graph of water permeability vs. ion exchange capacity for styrene-based ion exchange resins.

FIG. 22 shows the chemical structure of an exemplary novel styrene-based ion exchange resin structure, with maximum ion exchange capacity (IEC) of up to 6.2 meq/g.

FIG. 23 shows an exemplary pervaporation device with a pervaporation membrane such that a liquid flows on one side of the membrane and air flows on the other side of the membrane. Water transfers from either side of the membrane based on vapor pressure gradient.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

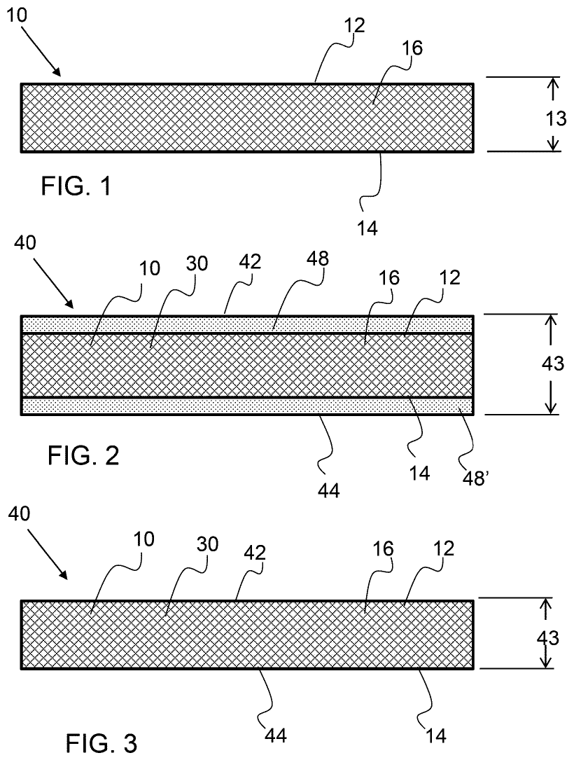

As shown in FIG. 1, an exemplary an ultra-thin porous scaffold support 10 is a thin sheet or porous membrane having a top side 12, bottom side 14 and pores 16 therethrough from the top to the bottom. An exemplary porous scaffold support is a planar sheet of material may be an ultra-thin porous scaffold support having a thickness 13 of less than 50 μm, and preferably less than 25 μm, as described herein.

As shown in FIG. 2, an exemplary ultra-thin composite PEBA film 40 has PEBA polymer 30 imbibed into the pores 16 of the porous scaffold support 10. This may be accomplished by melt extruding, and/or melt laminating and pressing PEBA resin into the pores of the porous scaffold material, or through solution casting or imbibing. The composite PEBA film has a top surface 42 and a bottom surface 44 and a thickness 43 therebetween. The thickness of the composite PEBA film is preferably less than 50 μm, more preferably less than 25 μm and even more preferably less than 10 μm or 5 μm. There is a PEBA butter coat layer 48, 48′ extending across the top side 12 and bottom side 14 of the porous scaffold support, respectively. A butter coat layer is a thick layer of the PEBA copolymer extending over the porous scaffold support. A butter-coat layer may be on one or both surfaces of the composite PEBA film.

As shown in FIG. 3, an exemplary ultra-thin composite PEBA film 40 has PEBA polymer 30 imbibed into the pores 16 of the porous scaffold support 10. This may be accomplished by melt laminating and pressing PEBA resin into the pores of the porous scaffold material, or through solution casting or imbibing. In this embodiment, there is no butter-coat layer.

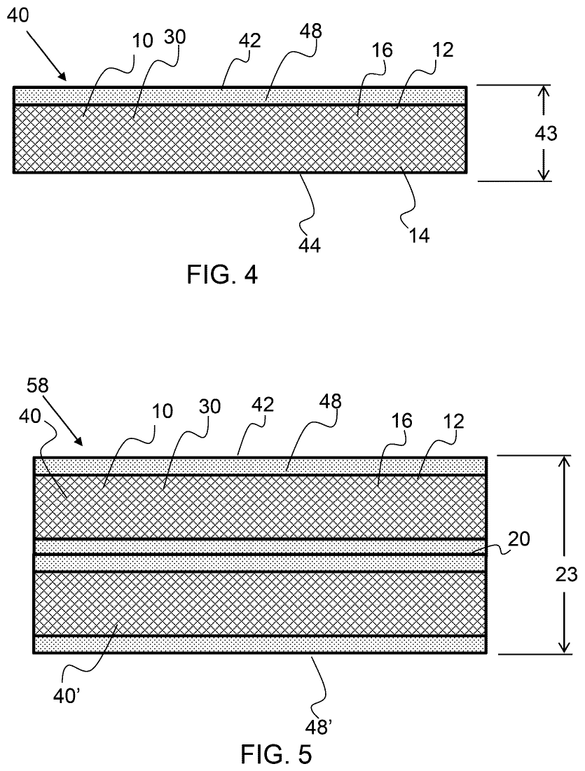

As shown in FIG. 4, a composite PEBA film 40 has a butter-coat layer 48 of PEBA copolymer 30 on the top side 12 or surface of a porous scaffold support 10. This thin composite PEBA film may be used in a flat sheet in a pervaporation module or in a humidification vent application to allow humidity to pass therethrough but to exclude other contaminants or particles from entering an enclosure. As shown in FIG. 4, a flat sheet of a composite PEBA film may be made for plate and frame configurations. It may be preferable to use this single sided butter-coat layer composite PEBA film for these applications as the PEBA may be very thin, such as less than 10 μm or even more preferably less than 5 μm.

FIG. 5 shows a cross-sectional view of an overlap area 58 of a composite PEBA tube having two layers of composite PEBA film 40 and 40′. The overlap area is fused together along the fused interface 20 which may include PEBA from one butter-coat layer melting into the PEBA of the adjacent butter-coat layer. Note that PEBA from one composite PEBA film may melt into the pores or other PEBA polymer in an adjacent composite PEBA film. The thickness 23 of the overlap area 58 or layers is greater than the thickness of a single composite PEBA film, and therefore reducing the overlap area is important to increase throughput and permeation rates through the tube.

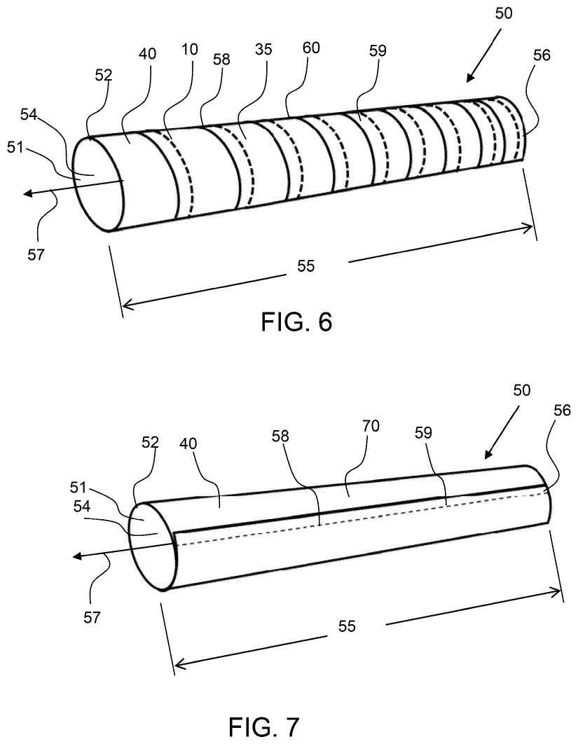

As shown in FIG. 6, a composite PEBA tube 50 is a spirally wrapped PEBA tube 60 having a composite PEBA film 40 spirally wrapped to form the outer wall 52 and conduit 51 of the spirally wrapped PEBA tube. The spirally wrapped PEBA tube has overlap areas 58 that spiral around the tube. The composite PEBA film that may be attached or bonded to each other to form bonded area 59. The bonding may be formed by fusing the layers together, wherein the PEBA from one layer is intermingled with the PEBA of the second, or overlapped layer. This bonding may be accomplished through heat, such as by fusing or by the addition of a solvent that enables intermingling of the polymers. The composite PEBA tube 50 has a length 55 from an inlet 54 to an outlet 56 and a length axis 57 extending along the center of the tube. A first layer of the composite PEBA film is bonded to the PEBA polymer of a second layer of the composite PEBA film to form the bonded area. As described herein, the overlap width may be fraction of the tape width, such as no more than about 30% of the tape width, no more than about 25% of the tape width, no more than about 20% of the tape width, no more than about 10% of the tape width, or even no more than about 5% of the tape width to provide a high percentage of the spiral wrapped tube that is only a single layer, thereby increase the rate of transfer of ions through the tube and also reduce the total usage of film thus lower cost. This spiral PEBA film may include an ultra-thin extruded PEBA layer 35 which may be coupled to a porous scaffold support layer 10 as shown in FIGS. 2 to 5 to produce a composite PEBA film 40.

As shown in FIG. 7, a composite PEBA tube 50 is a longitudinally wrapped PEBA tube 70 having a composite PEBA film 40 longitudinally wrapped to form the longitudinally wrapped PEBA tube and tube conduit 51. The longitudinally wrapped PEBA tube has an overlap area 58 of the composite PEBA film that extends down along the length 55 or length axis 57 of the tube. The length extends from the inlet 54 to the outlet 56. The overlap area may be attached or bonded to each other to form a fused area 59 wherein the layers of the composite PEBA film are bonded or fused together, wherein the PEBA from one layer is intermingled with the PEBA of a second layer through melting or solvent bonding. The bonding may be formed by fusing the layers together, wherein the PEBA from one layer is intermingled with the PEBA of the second, or overlapped layer. This bonding may be accomplished through heat, such as by fusing or by the addition of a solvent that enables intermingling of the polymers. An exemplary composite PEBA pervaporation tube comprises a longitudinally wrapped, or “cigarette wrapped” composite PEBA film sheet to form a longitudinal wrapped PEBA pervaporation tube. The composite PEBA film is wrapped around the longitudinal axis of the tube. In this embodiment the length of the tube is the width of the composite PEBA film, and the wrap angle is perpendicular to the longitudinal axis. The longitudinal wrapped composite PEBA film has an overlap area having an overlap width. Again, the overlap width may be no more than about 30% of the tape width, no more than about 25% of the tape width, no more than about 20% of the tape width, no more than about 10% of the tape width, or even no more than about 5% of the tape width to provide a high percentage of the spiral wrapped tube that is only a single layer, thereby increase the rate of permeation and transfer of ions through the tube. This wrapped PEBA film may include an ultra-thin extruded PEBA layer 35 which may be coupled to a porous scaffold support layer 10 as shown in FIGS. 2 to 5 to produce a composite PEBA film 40.

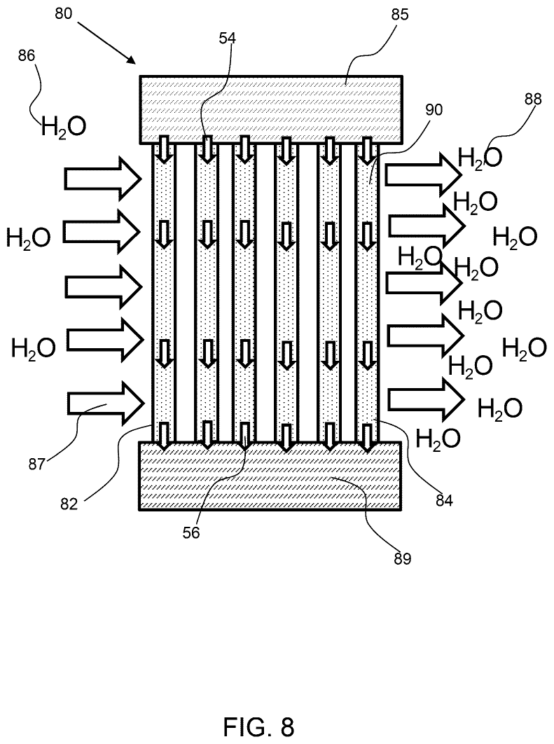

FIG. 8 shows a pervaporation module 80 comprises a plurality of PEBA pervaporation tubes 82 that are composite PEBA pervaporation tubes 84, as described herein 32. Each of the tubes is coupled to an inlet tube sheet 85 and outlet tube sheet 89. A flow of water flows through the plurality of tubes from the inlet 54 to the outlet 56 of the tube. An airflow 87 passes over the tubes to pull away moisture. The inlet relative humidity 86 may be much lower than the outlet relative humidity 88. Each of the composite PEBA tubes may further comprise a tube support 90, which is an additional support structure or tube that extends around the composite PEBA tubes to prevent expansion of the composite PEBA tubes under pressure. The water flowing through the tubes may be pressurized to increase permeation therethrough and a tube support may prevent diameter creep or swelling. A tube support may be a net or screen that is resistant to radial forces that would increase the diameter and may be made of rigid polymer material and/or a metal, such as a porous metal tube including, but not limited to a, perforated metal tube or woven metal tube.

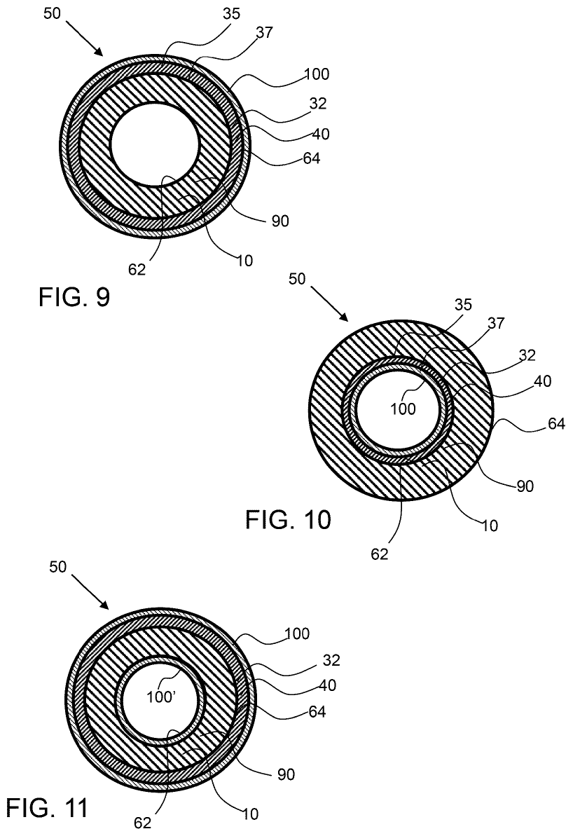

As shown in FIG. 9, an exemplary composite PEBA tube 50 has a PEBA polymer layer 32 on the outside surface 64 of the composite tube comprising a porous scaffold support 10. The composite PEBA tube has a film layer 100 configured over the wrapped composite PEBA film 40 to provide additional support and prevent leakage. An exemplary film layer may be thin, having a thickness no more than about 15 μm more than about 10 μm, no more than about 5 μm, no more than about 2 μm, no more than about 1 μm and any range between and including the thickness values provided. When the film layer is or comprises PEBA, the thinner the better for moisture transfer rates. The PEBA polymer 30 may be an ultra-thin PEBA film 35 as described herein, or an ultra-thin extruded PEBA tube 37.

As shown in FIG. 10 an exemplary composite PEBA tube 50 has a PEBA polymer layer 32 on the inside surface 62 of the composite tube comprising a porous scaffold support 10. The composite PEBA tube has a film layer 100 configured over the wrapped composite PEBA film 40 to provide additional support and prevent leakage.

As shown in FIG. 11, an exemplary composite PEBA tube 50 has a PEBA polymer layer 32 on both the inside surface 62 and the outside surface 64 of the composite tube comprising a porous scaffold support 10. The composite PEBA tube has a film layer 100, 100′ configured over the wrapped composite PEBA film 40 on the outside surface and inside surface, respectively, to provide additional support and prevent leakage. The tube may be an extruded tube.

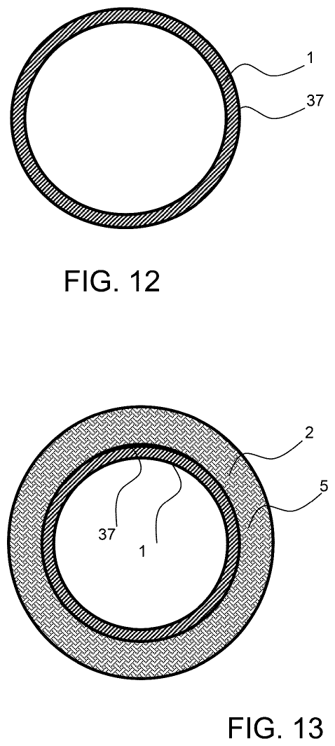

As shown in FIG. 12, an exemplary an ultra-thin extruded PEBA tube 37 has a tube wall 1 with a tube wall thickness of less than 75 μm or preferably less than 50 μm, as described herein.

As shown in FIG. 13, an exemplary ultra-thin PEBA tube 37 has a reinforcement 2 on the outer wall in the form of a braided sleeve 5. The reinforcement can be on the inner wall or embedded within the wall as described herein. The braided sleeve can be made out of metal or a polymer for example.

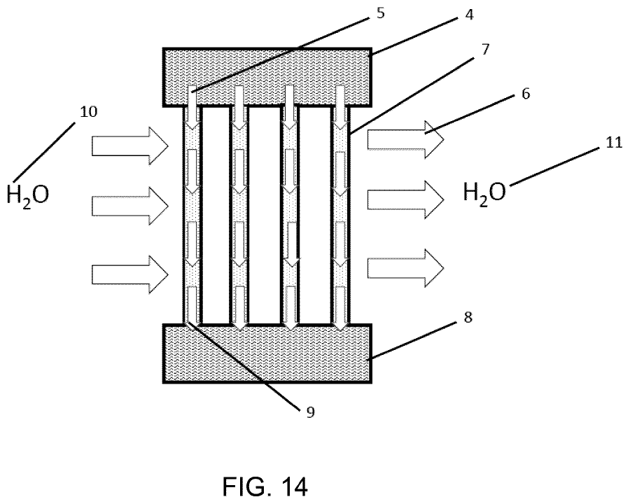

FIG. 14 shows a pervaporation module 80 comprising a plurality of PEBA pervaporation tubes 7 as described herein. Each of the tubes is coupled to an inlet tube sheet 4 and outlet tube sheet 8. A flow of water flows through the plurality of tubes from the inlet 5 to the outlet 9 of the tube. An airflow 6 passes over the tubes to pull away moisture. The inlet relative humidity 10 may be much lower than the outlet relative humidity 11. Each of the composite PEBA tubes may further comprise a tube support 3, which is an additional support structure or tube that extends around the composite PEBA tubes to prevent expansion of the composite PEBA tubes under pressure. The water flowing through the tubes may be pressurized to increase permeation therethrough and a tube support may prevent diameter creep or swelling. A tube support may be a net or screen that is resistant to radial forces that would increase the diameter and may be made of rigid polymer material and/or a metal, such as a porous metal tube including, but not limited to a, perforated metal tube or woven metal tube.

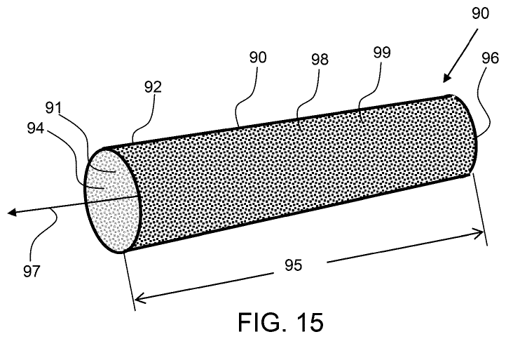

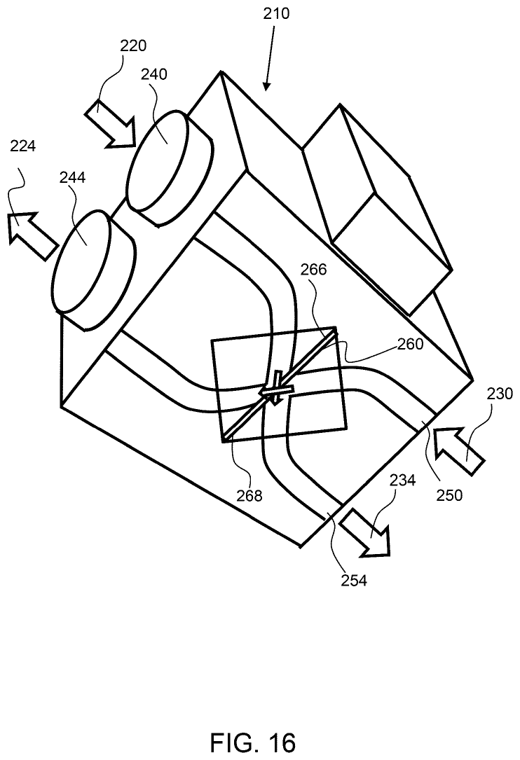

FIG. 15 shows a perspective view of an exemplary tube support 90 that is permeable having apertures 98 therethrough or tube pores 99 that allows for the permeation of water or water vapor therethrough. The tube support has a tube wall 92 with an outside surface and an inside surface forming a tube conduit 91. The tube support has a length 95 from an inlet 94 to the outlet 96. The conduit extends along a length axis 97. An extruded PEBA tube may be configured around the outside surface or within the conduit of the tube support and the extruded PEBA tube may be composite extruded PEBA tube having a porous scaffold support layer.

Non-permeable, as used herein, is defined as a material having greater than a 500 second Gurley Densometer reading, as measured using an automatic Gurley Densometer 4340, from Gurley Precision Instruments, Inc., Troy, NY.

As shown in FIG. 16, an exemplary energy recovery ventilator 210 utilizes a composite ion exchange membrane 260 to transfer heat and humidity from extract air 230 to intake air 220. The intake air 220 enters through an intake air inlet 240 and flow past the intake side 66 of the composite ion exchange membrane before exiting through the exhaust air outlet 244 as exhaust air 224. The exchange air 230 enters through the extract air inlet 250 and flows past the composite ion exchange membrane before exiting through the supply air outlet 254 as supply air 234. Heat and/or humidity are exchanged through the composite ion exchange membrane from the exchange air to the intake air. This system may be a low cost way to keep air fresh in a room or to reduce humidity in an enclosed space.

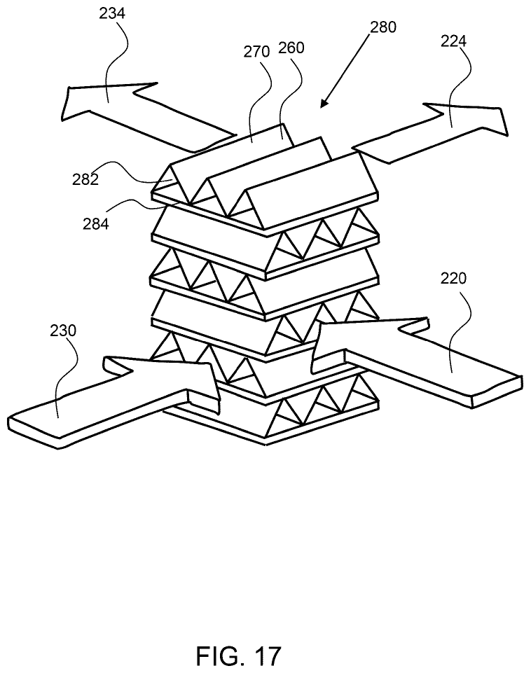

As shown in FIG. 17, the composite ion exchange membrane may be configured into an exchange module 280 having flow channels 282 formed from pleats 270 of the composite ion exchange membrane 260. A flow channel may be formed on one side by the pleated composite ion exchange membrane and on the opposing side by a flat sheet layer 284 of the composite ion exchange membrane.

### Core Design

The core of an energy recovery ventilator may have pleated or corrugated supports for the transfer medium, or ion exchange membrane, as shown in FIG. 17.

### Airflow Design

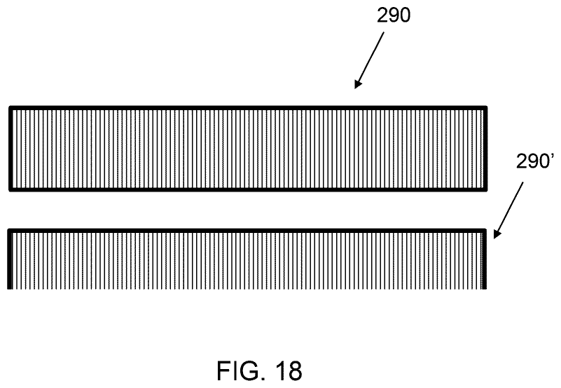

A twister 290 or 290′, as generally shown in FIG. 18 may create turbulent flow through the energy recovery ventilator which may enhance exchange through the composite ion exchange membrane. A twister comprises a plurality of elongated members that extend into the flow of the intake air and/or extract air.

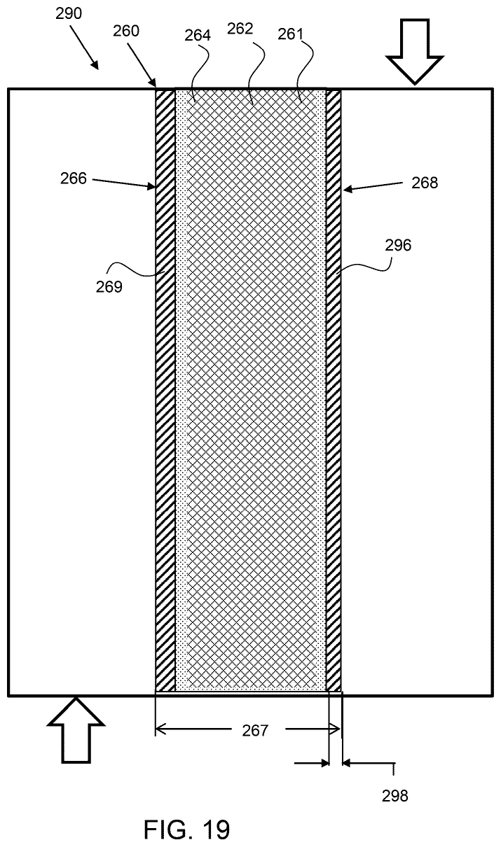

As shown in FIG. 19, a composite ion exchange membrane 60 comprises a porous polyolefin 262 and an exchange polymer 264, which may be an ionomer. The porous polyolefin acts as a support layer for the exchange polymer and has pores that extend through the thickness. The exchange polymer may be coated on one or both sides of the porous polyolefin layer and/or may be imbibed into the pores of the porous polyolefin, as shown. The composite exchange membrane 260 has an intake side 266, exposed to the intake air, and an extract side 268, exposed to the extract air. The thickness 267 of the composite exchange membrane 260, such as an ion exchange membrane, may be very low, such as no more than about 250 microns, no more than about 25 microns, no more than about 15 microns, no more than about 10 microns and even no more than 5 microns, and any range between and including the values provided. The thinner the composite ion exchange membrane, the more transfer of heat and humidity through the layer.

A pervaporation membrane may include a composite ion exchange membrane 60 that may include a thin-film of an exchange polymer, such as an ionomer, including a perfluorosulfonic acid (PFSA), which may be a continuous film, having a thickness 298 that is ultra-thin, as described herein, having a thickness of less than 5 microns. This or these thin-films of exchange polymer render the composite exchange membrane non-permeable to a bulk flow of gas, as described herein as having a 500 second or more time reading as measured using an automatic Gurley Densometer 4340, from Gurley Precision Instruments, Inc., Troy, NY. The thin-film of exchange polymer 269 may be on the intake side 266 and/or a thin-film of exchange polymer 296 may be on the extract side 268. A thin-film of exchange polymer on the air side is preferred as it will prevent contamination of the porous support layer 261, such as a porous polyolefin 262.

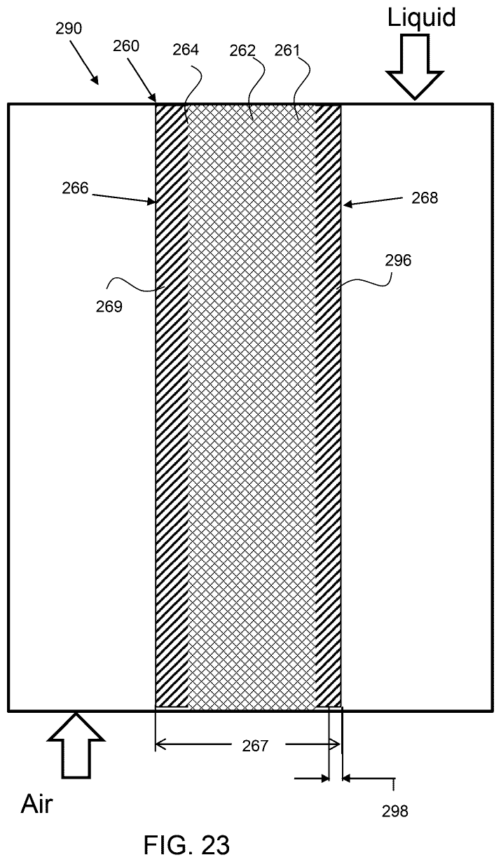

As shown in FIG. 23 a composite exchange membrane 260 comprises a porous polyolefin 262 and an exchange polymer 264, which may be an ionomer, or other exchange polymer that is not ionically conductive. The porous polyolefin acts as a support layer for the ionomer and has pores that extend through the thickness. The exchange polymer may be coated on one or both sides of the porous polyolefin layer and/or may not completely imbibed into the pores of the porous polyolefin, to enable the porous support to be permeable. The composite ion exchange membrane 260 has a side, exposed to air, and a side, exposed to a liquid such as water in evaporative cooler and a salt such as Lithium Chloride in a liquid desiccant system. The thickness 267 of the composite ion exchange membrane 60 may be very low, such as no more than about 50 microns, no more than about 25 microns, no more than about 15 microns, no more than about 10 microns and even no more than 5 microns, and any range between and including the values provided. The thinner the composite ion exchange membrane, the more transfer of heat and humidity through the layer. A pervaporation membrane may include a composite ion exchange membrane 260 that may include a thin-film of an exchange polymer, such as an ionomer such as perfluorosulfonic acid (PFSA), which may be a continuous film, having a thickness 298 that is less ultra-thin, as described herein, having a thickness of less than 5 microns. This or these thin-films of exchange polymer render the composite exchange membrane non-permeable to a bulk flow of gas, as described herein as having a 500 second or more time reading as measured using an automatic Gurley Densometer 4340, from Gurley Precision Instruments, Inc., Troy, NY. The thin-film of exchange polymer 269 may be on the air side and/or a thin-film of exchange polymer 296 may be on the liquid side. A thin-film of exchange polymer on the air side is preferred as it will prevent contamination of the porous support layer 261, such as a porous polyolefin 262. The porous support may be porous and have very high moisture vapor transmission and the thin-film exchange polymer may have a high moisture vapor transmission rate to provide a composite with a higher moisture vapor transmission rate than a composite with exchange polymer imbibed into the porous scaffold to substantially fill the pores of the porous scaffold to render it non-permeable, as described herein.

### New High-Performance Membranes:

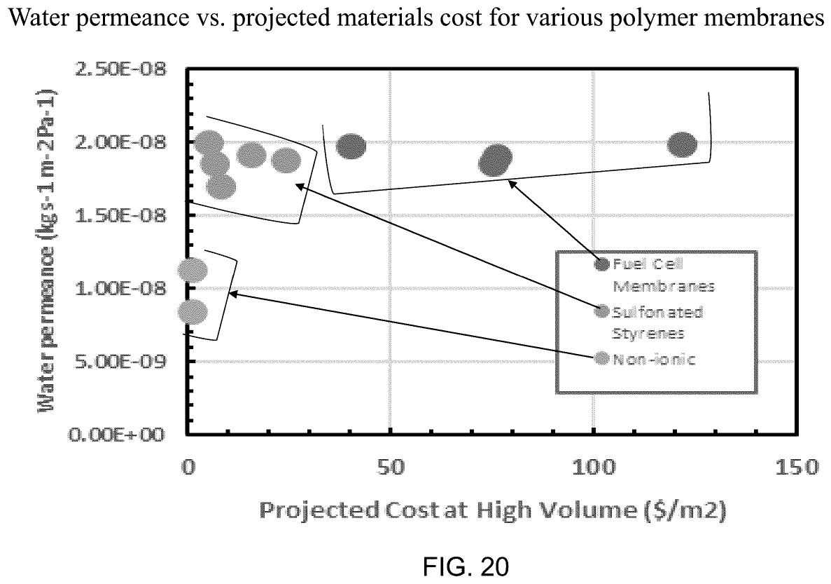

Ion exchange membranes, typically used for electrochemical applications, demonstrate the properties required for an enhanced ERV membrane. High water permeances (2.00×10⁻⁸ kg s⁻¹ m⁻² Pa⁻¹, FIG. 20) can be achieved with both cation-exchange membranes (such as commercially-available perfluorosulfonic acid (PFSA) membranes) and novel anion exchange membranes, typically used for fuel cells. Traditional ion exchange resins are prohibitively expensive (generally, a bare minimum of $50/m² when cast into a composite membrane suitable for ERVs). However, application of thin-film of exchange polymer (<5 um) of exchange polymer, such as an ionomer, on one side of a porous material (the side that contacts the air) is sufficient in most cases to realize the benefits of improved permeance and resistance to chemicals and fouling. In such an embodiment, the cost of a perfluorosulfonic acid (PFSA) membrane can be in the range of $5-$20/m². Therefore, in applications such as liquid-based air conditioning, evaporative cooling and other pervaporation processes involving harsh chemicals, the above embodiment demonstrates an improvement in properties as compared to porous membranes and can be produced at a justifiable low cost.

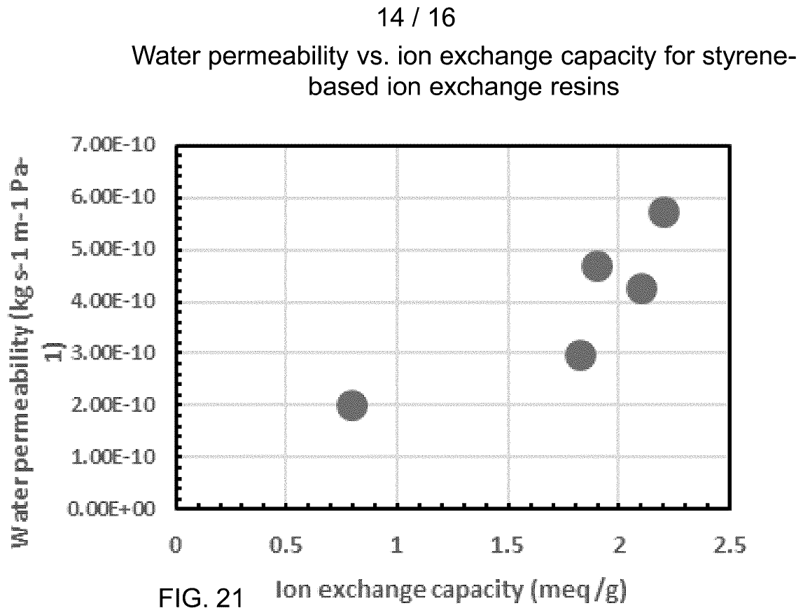

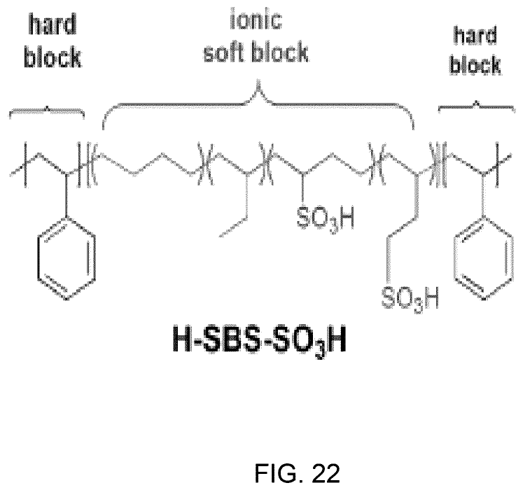

Other ion exchange materials exist that demonstrate similar water transport properties to fuel cell membranes while being based on less expensive, commodity chemicals. For example, sulfonated polystyrene or sulfonated styrene-ethylene-butadiene (SEBS) copolymers offer high water permeance (2.00×10⁻⁸ kg s⁻¹ m⁻² Pa⁻¹) at a low (approx. $5/m²) cost (FIG. 20). These materials are currently in use for ERV applications. However, none of them have ion exchange capacity (IEC) greater than 2.5 meq/g. There is a correlation between IEC (the degree to which the polymer is functionalized) and water permeability (the thickness-independent property of a material to transport water) (FIG. 21). With new synthesis techniques, ion exchange resins based on commodity SEBS polymers can be produced with an IEC up to 6.0 meq/g (FIG. 22), more than twice that of commercially-available resins. Although these copolymers retain some mechanical strength, they do need to be ‘composited’ i.e. combined with a thin, porous support layer, to improve dimensional stability and provide additional mechanical reinforcement in operation.

One key element of this advanced composite material is the use of porous polyethylene or polypropylene as the support matrix versus expanded polytetrafluoroethylene (ePTFE) as patented by W. L. Gore and Associates. Polyolefins are more suited to many Non-fluorinated exchange polymer, such as ionomers, such as SEBS, but also advanced phenyls-based systems as patented by Rensselaer Polytechnic Institute and University of Delaware. Porous Polyolefins can be produced in a number of different ways which is more commonly used as a separator for lithium-ion batteries. Its use as a base for composite ion exchange media is novel. These materials can be made via solvent extrusion or an expansion process similar to the production of expanded PTFE (ePTFE), by using Ultra-high-molecular-weight polyethylene (UHMWPE) i.e. producing a compressed puck from powders, then pultruding through a die (with temperature, and solvent) and then subsequent expansion to stretch out the pultruded film to many times the width of the slot die. Because they are not perfluorinated substrates, the physical compatibility of the exchange polymers and solutions is improved with these alternates substrates.

### Novel Core Construction:

Without fundamental changes in core design and construction, advanced membranes cannot operate to their full potential. It is well known that traditional construction methods employed to build ERV cores use corrugated triangular spacers between membrane sheets to enable air flow. This is a low cost, simple approach that provides for essentially-laminar flow across the membrane. To reduce resistance due to boundary layer formation in ERV cores, the present invention contemplates the integration of ‘air twisters’ into the ERV core right at the inlet to air (see attached photograph). The degree of rotation (turbulence, as expressed by measured Reynolds number), the length of the air twisters, and overall width of the air slot are important parameters that must be optimized to obtain optimum energy recovery. A schematic of this design is provided.

The exchange polymer may be a styrene based ion exchange material, as shown in FIG. 7, and may have a maximum exchange capacity of up to 6.2 meq/g.

### REFERENCES

The entirety of all references listed below are hereby incorporated by reference herein.
1. AHRI. Confidential Reports: Air-to-Air Energy Recovery Ventilation Equipment. 2017.
2.-. Confidential Reports: Air-to-Air Energy Recovery Ventilation Equipment. 2016.
3. MarketsandMarkets. Energy Recovery Ventilator Market—Global Forecast to 2021.2016.
4. Engineering Weather Data. [CD] Asheville, NC: National Climatic Data Center, 2000.
5. Zhang L Z, Niu J L., Energy requirements for conditioning fresh air and the long-term savings with a membrane-based energy recovery ventilator in Hong Kong. Energy 2001; 26:119-35.
6. Jason Woods, Membrane processes for heating, ventilation, and air conditioning, Renewable and Sustainable Energy Reviews 33 (2014) 290-304
7. Heat transfer and pressure drop in spacer-filled channels for membrane energy recovery ventilators. Jason Woods, Eric Kozubal. 2013, Applied Thermal Engineering, pp. 868-876.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. An advanced energy recovery ventilator comprising:
a) an ion exchange membrane comprising:
i) a porous support layer having a thickness and comprising a plurality of pores that extend through the thickness;
ii) a polyether block amides (PEBA) ion exchange polymer coupled to the porous support layer;
iii) an intake side;
iv) an extract side that is opposite the intake side;
wherein the composite ion exchange membrane is non-permeable, having a Gurley Densometer reading of at least 500 seconds;
b) an intake air inlet for receiving intake air
c) an exhaust air outlet;
wherein intake air enters the intake air inlet, passes by the intake side of said composite ion exchange membrane and exits the exhaust air outlet of the energy recovery ventilator as exhaust air;
d) an extract air inlet for receiving extract air; and
e) a supply air outlet;
wherein extract air enters the extract air inlet, passes by the extract side of said composite ion exchange membrane and exits the supply air outlet of the energy recovery ventilator as supply air.

2. The advanced energy recovery ventilator of claim 1, wherein the polyether block amides (PEBA) ion exchange polymer is configured as a thin-film on at least one of the intake side and extract side of the composite ion exchange membrane; wherein the thin-film has a thickness of no more than 50 um.

3. The advanced energy recovery ventilator of claim 2, wherein the thin-film of exchange polymer is no more than 5 microns thick.

4. The advanced energy recovery ventilator of claim 2, wherein the thin-film of exchange polymer is between 1 micron and 5 microns thick.

5. The advanced energy recovery ventilator of claim 1, wherein the polyether block amides (PEBA) ion exchange polymer is configured as a thin-film on intake side of the composite ion exchange membrane; wherein the thin-film has a thickness of no more than 50 um.

6. The advanced energy recovery ventilator of claim 5, wherein the thin-film of exchange polymer is no more than 5 microns thick.

7. The advanced energy recovery ventilator of claim 5, wherein the thin-film of exchange polymer is between 1 micron and 5 microns thick.

8. The advanced energy recovery ventilator of claim 1, wherein the polyether block amides (PEBA) ion exchange polymer is configured as a thin-film on extract side of the composite ion exchange membrane; wherein the thin-film has a thickness of no more than 50 um.

9. The advanced energy recovery ventilator of claim 8, wherein the thin-film of exchange polymer is no more than 5 microns thick.

10. The advanced energy recovery ventilator of claim 8, wherein the thin-film of exchange polymer is between 1 micron and 5 microns thick.

11. The advanced energy recovery ventilator of claim 1, wherein the polyether block amides (PEBA) ion exchange polymer is configured as a thin-film on both of the intake side and extract side of the composite ion exchange membrane; wherein the thin-film has a thickness of no more than 50 um.

12. The advanced energy recovery ventilator of claim 11, wherein the thin-film of exchange polymer on each of the intake and extract side is no more than 5 microns thick.

13. The advanced energy recovery ventilator of claim 11, wherein the thin-film of exchange polymer on each of the intake and extract side is between 1 micron and 5 microns thick.

14. The advanced energy recovery ventilator of claim 1, wherein the composite ion exchange membrane is configured in an exchange module comprising a plurality of flow channels configured from corrugated composite exchange membrane.

15. The advanced energy recovery ventilator of claim 1, wherein the support layer is a porous polyolefin.

16. The advanced energy recovery ventilator of claim 1, wherein the polyether block amides (PEBA) ion exchange polymer is an extruded tube.
